(19) United States
(12) Patent Application Publication
(10) Pub. No.: US 2017/0161564 A1
(43) Pub. Date: Jun. 8, 2017

(54) Queue Monitoring Based on Imprint Profiles

(71) Applicant: International Consolidated Airlines Group, Hounslow (GB)

(72) Inventors: Daniel JOBLING, Hounslow (GB); Glenn MORGAN, Hounslow (GB)

(21) Appl. No.: 15/366,904

(22) Filed: Dec. 1, 2016

(30) Foreign Application Priority Data
Dec. 3, 2015 (GB) 1521344.0

(51) Int. Cl. G06K 9/00; G01J 5/00; G01L 1/00; G06K 9/62; H04N 5/33

(52) U.S. Cl. CPC G06K 9/00778; G06K 9/6202; H04N 5/33; G01L 1/00; G01J 5/0025; G01J 2005/0081; G01J 2005/0077

(57) ABSTRACT

Systems and methods for queue monitoring are described, whereby imprint data is captured from people entering a first zone of a monitored queue area at respective times, and a corresponding profile is determined for each person entering the first zone based on the respective captured imprint data. Imprint data is captured from a person entering a second zone of the monitored queue area at a respective time, and a corresponding profile is determined based on the respective captured imprint data. The profile of the person entering the second zone is compared to the profiles of people entering the first zone to determine a match. Queue measurements, such as a travel time between the zones, is computed from the relative capture times of the imprint data.

### FIELD OF THE INVENTION

This invention relates generally to computerised queue monitoring, and more particularly to data processing for queue measurement based on profiles computed from captured imprints.

### BACKGROUND

Queue monitoring systems are generally known, typically employing video image data processing to identify and track individuals within a monitored area. Other systems employ device tracking via WiFi® or BlueTooth® data connections to locate the associated individuals. While these conventional systems do provide queue measurement metrics, there are drawbacks with relying on cameras and/or data beacons to locate an individual. For example, image processing for facial recognition is often processor and data storage intensive, and detection accuracy can vary significantly due to any number of factors such as lighting, occlusions, variations in appearance, availability of matching user information in a database, etc. As another example, device-based tracking requires availability and connectivity to suitable computing devices and is prone to inaccurate location detection and tracking.

What is desired are more robust, efficient and accurate techniques for queue monitoring and measurement of queue metrics.

### SUMMARY OF THE INVENTION

Aspects of the present invention are set out in the accompanying claims.

According to one aspect, the present invention provides a queue monitoring system, comprising means for capturing imprint data from persons stepping into a first zone of a monitored queue area at respective times, and determining a corresponding profile for each person stepping into the first zone based on the respective captured imprint data; means for capturing imprint data from a person stepping into a second zone of the monitored queue area at a respective time, and determining a corresponding profile based on the respective captured imprint data; means for comparing the profile of the person stepping into the second zone to the profiles of persons stepping into the first zone to determine a matching one of said profiles of persons stepping into the first zone; and means for computing a travel time from the first zone to the second zone from the relative capture times of the captured imprint data corresponding to the matching profiles of the person stepping into the first and second zones.

Each zone may comprises at least one sensor for capturing respective imprint data. The sensor may comprises at least one pressure mat or array of pressure sensors, configured to capture data defining a pressure imprint in response to the person stepping into the respective zone. The pressure imprint may correspond to an impression of the person's foot or shoe in contact with a pressure mat of the respective zone. The pressure imprint may include a sequence of captured pressure imprints.

The sensor may additionally or alternatively comprise at least one thermal mat configured to capture data defining a heat imprint in response to the person stepping into the respective zone. The heat imprint may correspond to an imprint of the person's foot in contact with a thermal mat of the respective zone.

The first and second zones may be defined by the shape and size of the respective mats.

The sensor may additionally or alternatively comprise at least one thermographic camera configured to capture data defining a heat signature in response to the person stepping into the zone. The heat signature may corresponds to an imprint of the person's foot in contact with a floor area of a respective zone.

Each profile may include data identifying at least one or more characteristics. At least one characteristic may be selected from weight, weight distribution, pressure distribution, heat distribution, foot shape, shoe shape, gait, and any other type of biometric characteristic. The comparing means may be configured identify matching profiles by comparing the respective one or more characteristics based on predefined matching criteria.

The second zone may be located a predefined distance along a linear or non-linear path from the first zone. The first and second zones may comprise respective designated areas of a monitored queue area. The second zone may be located at a known distance from the first area.

The system may be further configured to calculate a flow rate between the first and second zone based on the known distance between zones and the computed travel time of the person stepping into the second zone. The system may be further configured to compute a queue length based on the captured imprint data. The matching profiles may be removed from the system after computing the travel time.

The system may be further configured to generate and output control signals and/or notification data messages in response to analysis of queue measurements based on the computed travel time. For example, the control signals may comprise machine instructions to passage control means, to open or close another queue area depending on a size and flow of the monitored queue area.

In another aspect, the present invention provides a computer implemented method for queue monitoring, comprising capturing imprint data from persons stepping into a first zone of a monitored queue area at respective times, and determining a corresponding profile for each person stepping into the first zone based on the respective captured imprint data; capturing imprint data from a person stepping into a second zone of the monitored queue area at a respective time, and determining a corresponding profile based on the respective captured imprint data; comparing the profile of the person stepping into the second zone to the profiles of persons stepping into the first zone to determine a matching one of said profiles of persons stepping into the first zone; and computing a travel time from the first zone to the second zone from the relative capture times of the captured imprint data corresponding to the matching profiles of the person stepping into the first and second zones.

In a further aspect, there is provided a computer program comprising machine readable instructions stored thereon arranged to cause a programmable device to become configured as any one of systems as described above.

### BRIEF DESCRIPTION OF THE DRAWINGS

There now follows, by way of example only, a detailed description of embodiments of the present invention, with references to the figures identified below.

FIG. 1 is a block diagram showing the main components of a queue monitoring system according to an embodiment of the invention.

FIG. 2 is a flow diagram illustrating the main processing steps performed by the system of FIG. 1 according to an embodiment.

FIG. 3 is a schematic illustration of an exemplary monitored queue area.

FIG. 4 is a diagram of an example of a computer system on which one or more of the functions of the described embodiments may be implemented.

### DESCRIPTION OF EMBODIMENTS

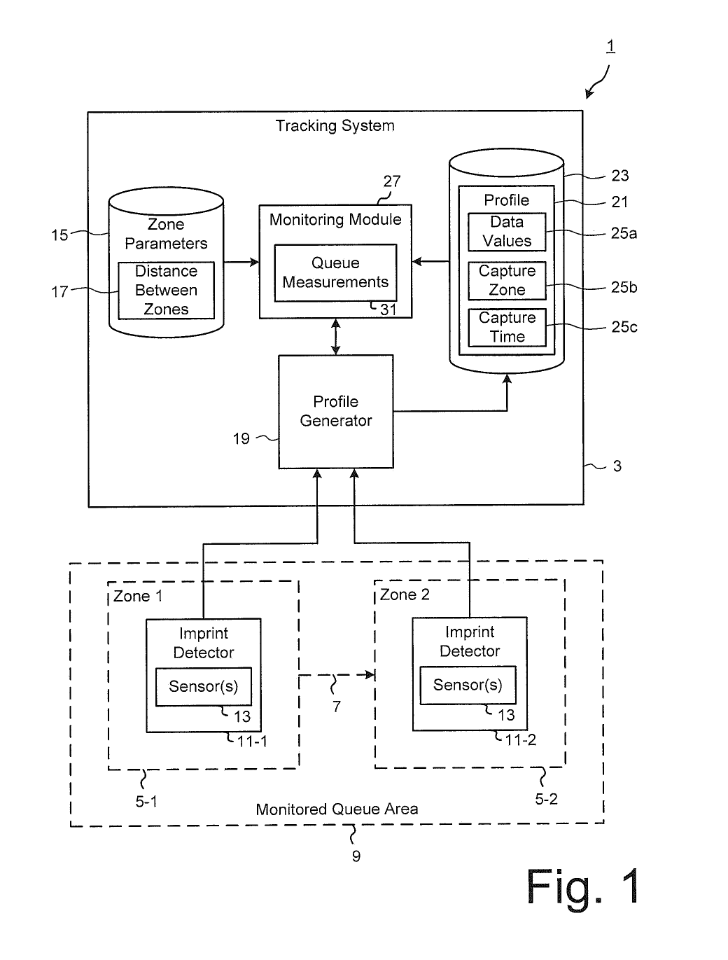

Referring to the schematic block diagram of FIG. 1, a system 1 for queue monitoring according to an embodiment comprises a tracking system 3 for processing received data and tracking the movement of people between predefined zones 5 along a travel path 7 of a monitored queue area 9. The monitored queue area 9 may be located at a service point such as a security checkpoint or gate in an airport terminal, a check-out kiosk or counter in a retail outlet, an automated teller or counter in a bank, a ticket machine in a station, or the like. In this context, the zones 5 may be defined at key locations or stages of the respective queue area 9 that will be traversed by every person passing through that queue area. Preferably, although not necessarily, a first zone is located at the start of the monitored queue area and a second zone is located at the end of the monitored queue area. The travel path 7 from the first zone 5-1 to the second zone 5-2 may be a linear path, or a non-linear path such as a curve, zig-zag or snake, etc.

The tracking system 3 is communicatively coupled to one or more imprint detectors 11-1 provided at a first zone 5-1 located along the travel path 7, and to one or more imprint detectors 11-2 provided at a second zone 5-2 located a known distance 11 from the first zone 5-1 along the travel path 7. The imprint detectors 11 capture imprint data in response to a person entering (or stepping into/onto) the respective zone 5 and transmit the captured imprint data to the tracking system 3 for processing. In one embodiment, each imprint detector 11 includes at least one pressure sensor 13, and preferably a plurality of pressure sensors (including a pressure mat or array/matrix of pressure sensors), configured to capture data defining a pressure imprint in response to the person entering the respective zone 5. Each pressure imprint corresponds to an impression of the person's foot or shoe in contact with the pressure sensor 13, which is positioned on the floor of the monitored queue area 9. The captured imprint data may indicate the variation of pressure distribution though the course of a person's step onto the pressure sensing layer 13, for example starting with the person's heel touching the pressure sensing layer and subsequently transferring force to the toes. The captured imprint data also includes data identifying the time the data was captured, and an identifier of the respective imprint detector 11 and/or zone 5. The imprint data may include a sequence of pressure imprints, for example corresponding to left and right foot steps along the pressure sensing layer 13.

Additionally or alternatively, each imprint detector 11 may include one or more thermal sensors 13 (including a thermal sensor mat or array of thermal sensors), configured to capture data defining a heat imprint in response to the person entering the zone 5. Each heat imprint corresponds to an imprint of the person's foot in contact with a thermal mat of a respective zone. As yet another alternative, each imprint detector 11 may include a thermographic imaging sensor 13 (also called a thermographic camera, infrared camera or thermal imaging camera), configured to capture data defining a heat signature in response to the person entering the zone. The thermographic sensor 13 may form an image of the imprint of the person's foot using infrared radiation to detect a residual heat signature left by the foot stepping on the floor or mat of the respective zone. Each zone 5 may be configured with a plurality of imprint detectors 11, each providing respective imprint data that can be used to generate a more comprehensive profile of the person entering the respective zone 5.

Such pressure and thermal sensors 13 are of types that are known per se, and need not be described further. Each imprint detector 11 may be communicatively coupled to the tracking system 3 via respective interfaces (not shown) for communicating data of one or more known types of data communication link, such as a computer data cabling system or a data network link, or a combination of the two.

The tracking system 3 may store zone parameter data 15 identifying the known distance 17 along the travel path 7 between the first and second zones 5. The stored data 15 may also identify the location of each of the zones 5 within the queue area 9, and unique identifiers of the respective imprint detector(s) 5 provided at each zone 5.

A profile generator 19 of the tracking system 3 receives captured imprint data from the respective imprint detectors 11 and determines a corresponding profile 21 based on the received imprint data. The profile generator 19 may store the generated profiles 21 in a working memory or database 23. The profile 21 may include computed data values 23a of one or more characteristics of the associated person, including weight, weight distribution, pressure distribution, heat distribution, foot shape, shoe shape, gait, or any other biometric characteristic. The profile 21 may also include data identifying the associated zone 25b and the time 25c that the respective imprint data was captured. Each generated profile 21 may also include a corresponding unique identifier representing the associated person entering the respective zone.

A monitoring module 27 of the tracking system 3 determines that a particular person has traversed from the first zone 5-1 to the second zone 5-2, by identifying matching profiles 21 derived from the imprint data received from the first and second imprint detectors 11. The monitoring module 27 may identify matching profiles 21 by comparing data values 25a of the respective one or more characteristics based on predefined matching criteria. After identifying matching profiles 21 associated with the same person from respective zones 5, the monitoring module 27 computes one or more queue measurements 31, including a travel time of the identified person traversing from the first zone 5-1 to the second zone 5-2 (i.e. from the defined start point of the monitored queue area to the defined end point). The monitoring module 27 may also update a count of people in the queue area, based on unique profiles entering the first zone, and matching profiles subsequently entering the second zone. The computed queue measurements 31 may be used by the monitoring module 27 to compute further queue measurements 31 for the associated queue area, such as queue flow rates, and to raise control signals and/or notifications in response to analysis of the queue measurements.

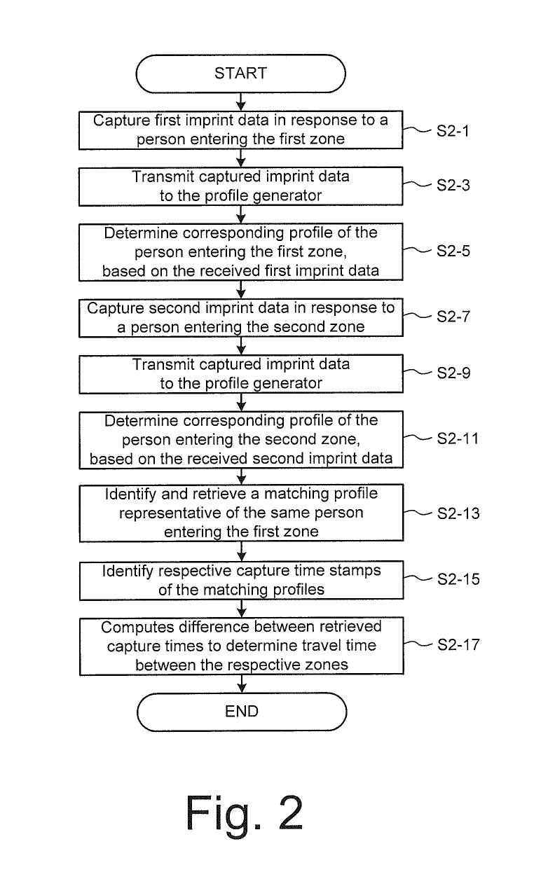

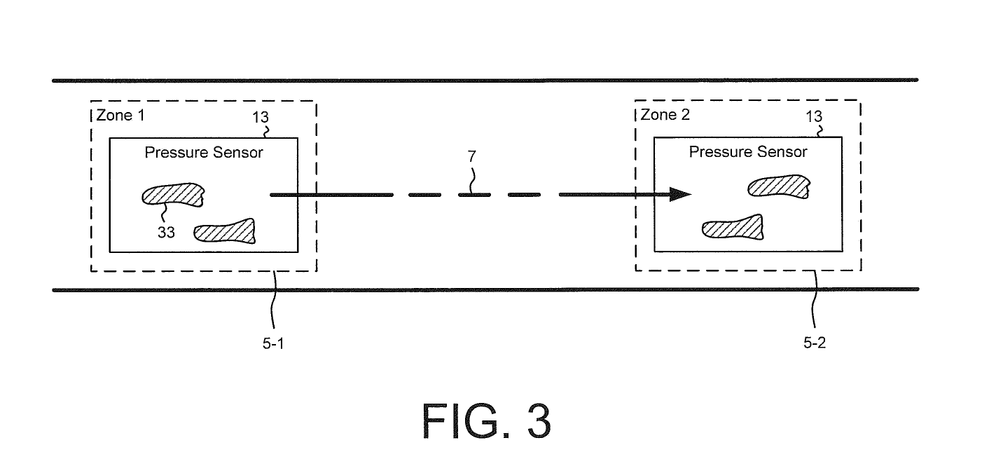

A more detailed description of the operation of the components forming part of the system 1 in this embodiment will now be given with reference to the flow diagrams of FIG. 2, for an example computer-implemented queue measurement process using the tracking system 3. Reference is also made to FIG. 3, schematically illustrating an example of a monitored queue area 9 having a first zone 5-1 located at an entrance to the monitored queue area 9 and a second zone 5-2 located at an exit of the monitored queue area 9. Each zone 5 has a respective imprint detector 11 to capture data representative of a person's foot print(s) 33 as the person steps within the surface area of a pressure mat 13 defining the respective zone 5.

As shown in FIG. 2, the process begins at step S2-1 where the imprint detector 11-1 of the first zone 5-1 captures imprint data in response to a person entering the first zone 5-1. In the example illustrated in FIG. 3, each zone 5 includes a pressure mat 13 (i.e. pressure sensor) of the respective imprint detector 11, located on a floor of the queue area, the pressure mat 13 having a surface area that defines the respective zone 5. Preferably, the size and shape of the pressure mat 13 is configured to enable a sequence of complete foot or shoe prints 33 to be captured as the person steps within the surface area of the pressure mat to traverse the zone. At step S2-3, the captured imprint data is transmitted by the first imprint detector 11-1 to the profile generator 19 of the tracking system 3. At step S2-5, the profile generator 19 determines a corresponding profile 21 of the person entering the first zone 5-1, based on the imprint data received from the imprint detector 11-1 of the first zone 5-1. The generated profile 21 is stored in the memory 23 for subsequent retrieval.

At step S2-7, the imprint detector 11-2 of the second zone 5-2 captures imprint data in response to a person entering the second zone 5-2. The person entering the second zone 5-2 at this step may or may not be the same person who entered the first zone 5-1 at step S2-1. At step S2-9, the second imprint data captured at step S2-5 is transmitted by the second imprint detector 11-1 to the profile generator 19 of the tracking system 3. At step S2-11, the profile generator 19 determines a corresponding profile of the person entering the second zone 5-2, based on the imprint data received from the imprint detector 11-2 of the second zone 5-2.

At step S2-13, the monitoring module 27 compares the profile of the person entering the second zone 5-2 with previously generated profiles of people entering the first zone 5-1, to identify and retrieve a matching profile representative of the same person entering the first zone 5-1. Optionally, if the monitoring module 27 does not find a matching profile, an alert or notification message may be generated for output by the system 1. The monitoring module 27 may identify a matching profile 21 by comparing corresponding data values 25a of one or more characteristics defined by matching criteria. For example, monitoring module 27 may compare one or more of:
The overall weight of the person, computed from either a single captured imprint or from captured imprints of both feet while the person is standing still on the pressure mat.
The shape of a captured shoe imprint, for example to classify the type of shoe, such as a boot compared to high heels, and/or to determine the pattern of the tread.
A shape characteristic associated with the left foot or shoe of a particular person, and a shape characteristic associated with the corresponding right foot or shoe of the same person, which should be a mirror image.
The pressure distribution as the person's foot lands on and subsequently lifts of the pressure mat.
A pressure-based signature, classifying unique behavioural traits such as a relatively hard impact from the back of the foot or shoe (i.e. the heel), distinct from a person who tends to walk on their front foot more.
Time and/or distance between sequential captured imprints along a respective pressure mat.

It will be appreciated that the specific types of characteristics available for comparison by the monitoring module 27 at this step will depend on the particular imprint detectors 11 that are used in the system 1 and the types of imprint data captured by the imprint detectors 11, as well as the algorithms implemented by the profile generator 19 to generate the profiles based on the captured imprint data. It is also appreciated that accuracy of the monitoring module 27 in matching the profile 21 of a person entering the second zone 5-2 to the profile 21 of the same person entering the first zone 5-1 may be correlated with the complexity of the generated profiles. For example, a more complex profile having a greater number of characteristics may result in more accurate identification of that same person rather than a person with a similar set of profile characteristics.

After identifying matching profiles 21 associated with the same person from respective zones 5, the monitoring module 27 identifies the respective capture time stamps 25c of the matching profiles 21, at step S2-15. At step S2-17, the monitoring module 27 computes the difference between the retrieved capture times 25c to determine the travel time of the identified person traversing from the first zone 5-1 to the second zone 5-2. The monitoring module 27 may also decrease the count of people in the monitored queue area 9, based on identifying a matching profile 21 subsequently entering the second zone 5-2, and thus exiting the monitored queue area 9. The computed queue measurements 31 may be used by the monitoring module 27 to compute further queue measurements 31 for the associated queue area, such as queue flow rates based on the calculated travel time by the identified person over the known distance 11 between first and second zones 5. Additionally, the system 1 may generate and output control signals and/or notification data messages in response to analysis of the computed queue measurements, for example to automatically open or close other queue areas depending on the size and flow of the or each monitored queue area.

Optionally, the stored profiles 21 for the identified person may be removed from the memory 23 after the queue measurements have been computed and/or updated. Maintaining the database of stored profiles in this way advantageously minimizes the possibility of retrieving a matching profile that is associated with a different person. It will be further appreciated that in this way, the number of candidate profiles 21 that are stored in the memory 23 at any given time will be directly related to the maximum queue size within the monitored queue area.

### Computer Systems

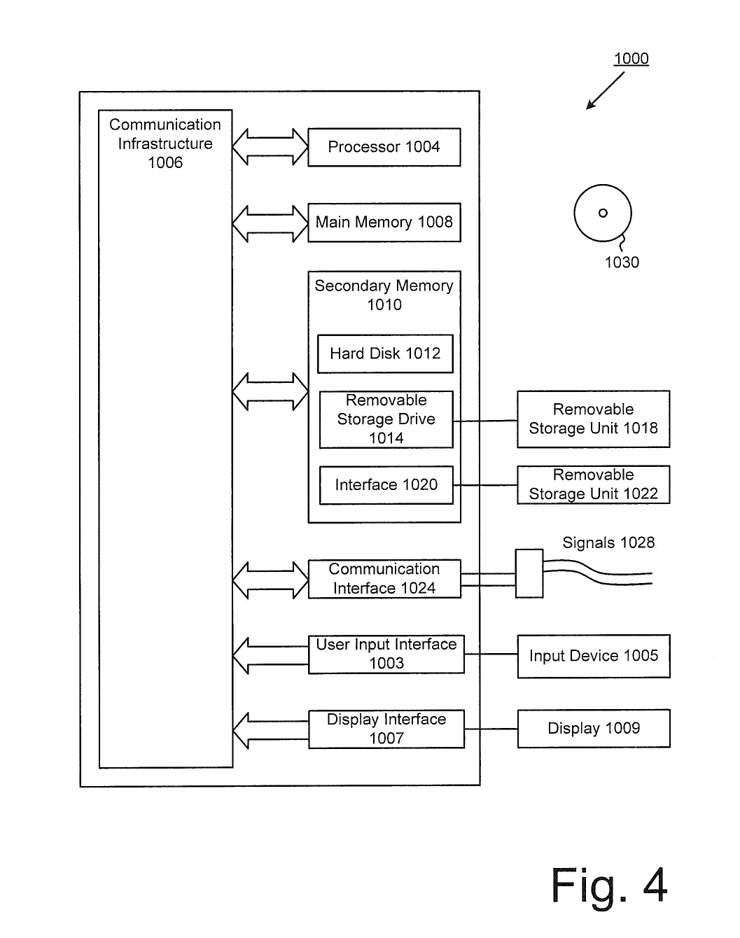

The entities described herein, such as the tracking system 3 and the imprint detectors 11, may each be implemented by one or more computer systems such as computer system 1000 as shown in FIG. 4. Embodiments of the present invention may be implemented as programmable code for execution by such computer systems 1000. After reading this description, it will become apparent to a person skilled in the art how to implement the invention using other computer systems and/or computer architectures.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

Computer system 1000 also includes a user input interface 1003 connected to one or more input device(s) 1005 and a display interface 1007 connected to one or more display(s) 1009. Input devices 1005 may include, for example, a pointing device such as a mouse or touchpad, a keyboard, a touchscreen such as a resistive or capacitive touchscreen, etc. After reading this description, it will become apparent to a person skilled in the art how to implement the invention using other computer systems and/or computer architectures, for example using mobile electronic devices with integrated input and display components.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 1018 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product 1030 and loaded into computer system 1000 using removable storage drive 1014, hard disk drive 1012, or communication interface 1024, to provide some examples.

### Alternative Embodiments May Be Implemented as Control Logic in Hardware, Firmware, or Software or Any Combination Thereof.

### Alternative Embodiments

It will be understood that embodiments of the present invention are described herein by way of example only, and that various changes and modifications may be made without departing from the scope of the invention.

For example, in the embodiments described above, the computed queue measurements may be used by the tracking module to generate and transmit control signals to a control means that selectively blocks traffic flow through the monitored queue area to prevent people entering the travel path when the queue size and/or throughput rate is over a predetermined threshold. The control means may be a door or gate installed across a passage of the monitored queue area. Additionally or alternatively, control signals may be generated and transmitted to control means of one or more adjacent passages when the queue size and/or throughput rate is over the predetermined threshold, to selectively unblock traffic flow through the respective passages and alleviate congestion at the monitored queue area.

In an embodiment described above, the tracking system is communicatively coupled to respective imprint detectors associated with each of the first and second zones, each imprint detector having a pressure mat (i.e. pressure sensor) located on the floor of that zone. As those skilled in the art will appreciate, a single pressure mat (and/or thermal mat) may instead be provided, spanning the first and second zones. In such an alternative, a corresponding single imprint detector may be provided to transmit captured pressure data to the profile generator for processing. The imprint detector or profile generator may map the pressure data captured from respective locations of the single pressure mat to the respective zones defined relative to the dimensions of the pressure mat, to identify the corresponding capture zone of the corresponding generated profile.

Reference in this specification to “one embodiment” are not necessarily all referring to the same embodiment, nor are separate or alternative embodiments mutually exclusive of other embodiments. In particular, it will be appreciated that aspects of the above discussed embodiments can be combined to form further embodiments. Similarly, various features are described which may be exhibited by some embodiments and not by others. Yet further alternative embodiments may be envisaged, which nevertheless fall within the scope of the following claims.

What is claimed is:

1. A queue monitoring system, comprising one or more computer processors configured to:
capture imprint data from people entering a first zone of a monitored queue area at respective times, and determine a corresponding profile for each person entering the first zone based on the respective captured imprint data;
capture imprint data from a person entering a second zone of the monitored queue area at a respective time, and determine a corresponding profile based on the respective captured imprint data;
compare the profile of the person entering the second zone to the profiles of people entering the first zone to determine a matching one of said profiles of people entering the first zone; and
compute a travel time from the first zone to the second zone from the relative capture times of the captured imprint data corresponding to the matching profiles of the person entering the first and second zones.

2. The system of claim 1, wherein each zone comprises at least one sensor for capturing respective imprint data.

3. The system of claim 2, wherein the sensor comprises at least one pressure mat configured to capture data defining a pressure imprint in response to the person entering the respective zone.

4. The system of claim 3, wherein the pressure imprint corresponds to an impression of the person's foot or shoe in contact with a pressure mat of the respective zone.

5. The system of claim 4, wherein the pressure imprint includes a sequence of captured pressure imprints.

6. The system of claim 2, wherein the sensor comprises at least one thermal mat configured to capture data defining a heat imprint in response to the person entering the respective zone.

7. The system of claim 6, wherein the heat imprint corresponds to an imprint of the person's foot in contact with a thermal mat of the respective zone.

8. The system of claim 3, wherein the first and second zones are defined by the shape and size of the respective mats.

9. The system of claim 3, wherein the first and second zones are defined by relative areas of a single mat.

10. The system of claim 2, wherein the sensor comprises at least one thermographic camera configured to capture data defining a heat signature in response to the person entering the zone.

11. The system of claim 10, wherein the heat signature corresponds to an imprint of the person's foot in contact with a floor area of a respective zone.

12. The system of claim 1, wherein each profile includes data identifying at least one or more characteristics.

13. The system of claim 12, wherein at least one characteristic is selected from weight, weight distribution, pressure distribution, heat distribution, foot shape, shoe shape and gait.

14. The system of claim 12, wherein the comparing means is configured identify matching profiles by comparing the respective one or more characteristics based on predefined matching criteria.

15. The system of claim 1, wherein the second zone is located a predefined distance along a linear path from the first zone.

16. The system of claim 1, wherein the second zone is located a predefined distance along a non-linear path from the first zone.

17. The system of claim 1, wherein the first and second zones comprise respective designated areas of a monitored queue area.

18. The system of claim 1, wherein the second zone is located at a known distance from the first area.

19. The system of claim 18, wherein the one or more computer processors are further configured to calculate a flow rate between the first and second zone based on the known distance between zones and the computed travel time of the person entering the second zone.

20. The system of claim 1, wherein the one or more computer processors are further configured to compute a queue length based on the captured imprint data.

21. The system of claim 1, wherein the matching profiles are removed from the system after computing the travel time.

22. The system of claim 1, wherein the one or more computer processors are further configured to generate and output control signals and/or notification data messages in response to analysis of queue measurements based on the computed travel time.

23. The system of claim 22, wherein the control signals comprise machine instructions to open or close another queue area depending on a size and flow of the monitored queue area.

24. A computer implemented method for queue monitoring, comprising:
capturing imprint data from people entering a first zone of a monitored queue area at respective times, and determining a corresponding profile for each person entering the first zone based on the respective captured imprint data;
capturing imprint data from a person entering a second zone of the monitored queue area at a respective time, and determining a corresponding profile based on the respective captured imprint data;
comparing the profile of the person entering the second zone to the profiles of people entering the first zone to determine a matching one of said profiles of people entering the first zone; and
computing a travel time from the first zone to the second zone from the relative capture times of the captured imprint data corresponding to the matching profiles of the person entering the first and second zones.

25. A non-transitory computer-readable medium comprising computer-executable instructions, that when executed perform the method of:
capturing imprint data from people entering a first zone of a monitored queue area at respective times, and determining a corresponding profile for each person entering the first zone based on the respective captured imprint data;
capturing imprint data from a person entering a second zone of the monitored queue area at a respective time, and determining a corresponding profile based on the respective captured imprint data;
comparing the profile of the person entering the second zone to the profiles of people entering the first zone to determine a matching one of said profiles of people entering the first zone; and
computing a travel time from the first zone to the second zone from the relative capture times of the captured imprint data corresponding to the matching profiles of the person entering the first and second zones.
